(19) United States
(12) Patent Application Publication
(10) Pub. No.: US 2023/0211357 A1
(43) Pub. Date: Jul. 6, 2023

(54) ELECTROSTATIC PRECIPITATOR

(71) Applicant: Edwards Limited, Burgess Hill, West Sussex (GB)

(72) Inventor: James Hann, Burgess Hill, Sussex (GB)

(21) Appl. No.: 18/001,121

(22) PCT Filed: Jun. 7, 2021
(86) PCT No.: PCT/GB2021/051404

§ 371 Date: Dec. 8, 2022

(30) Foreign Application Priority Data
Jun. 11, 2020 (GB) 2008865.4
Jun. 11, 2020 (GB) 2008866.2

(51) Int. Cl. B03C 3/41; B03C 3/78; B03C 3/06

(52) U.S. Cl. CPC B03C 3/41; B03C 3/78; B03C 3/06; B03C 2201/04; B03C 2201/10

(57) ABSTRACT

An electrostatic precipitator includes: a chamber having an inlet configured to receive an effluent stream for treatment and an outlet configured to convey a treated effluent stream; and an electrode structure housed within the chamber, the electrode structure being operable to generate a corona for treating the effluent stream to produce the treated effluent stream, wherein the electrode structure includes a comb structure having a shaft and a plurality of teeth extending from the shaft, the corona being generated at a free tip of each tooth in response to a voltage when applied across the electrode structure and the chamber The electrode teeth provide a reduced area from which the corona is generated, thereby improving the corona, but also the reduced size of the electrode teeth compared to existing electrode structures provides a reduced area for the accumulation of particulates and facilitates the shedding of those particulates from the electrodes.

### CROSS-REFERENCE OF RELATED APPLICATION

This application is a Section 371 National Stage Application of International Application No. PCT/GB2021/051404, filed Jun. 7, 2021, and published as WO 2021/250382A1 on Dec. 16, 2021, the content of which is hereby incorporated by reference in its entirety and which claims priority of British Application No. 2008866.2, filed Jun. 11, 2020 and British Application No. 2008865.4, filed Jun. 11, 2020.

### FIELD

The present invention relates to an electrostatic precipitator and method. Embodiments relate to an electrostatic precipitator for treating gas containing solid particles such as, for example, SiO₂ and acidic gases such as HCl.

### BACKGROUND

Electrostatic precipitators are known. Such apparatus are used for treatment of effluent gases arising from, for example, epitaxial deposition processes. Epitaxial deposition processes are increasingly used for high-speed semiconductor devices, both for silicon and compound semiconductor applications. An epitaxial layer is a carefully grown, single crystal silicon film. Epitaxial deposition utilizes a silicon source gas, typically silane or one of the chlorosilane compounds, such as trichlorosilane or dichlorosilane, in a hydrogen atmosphere at high temperature, typically around 800-1100° C., and under a vacuum condition. Epitaxial deposition processes are often doped with small amounts of boron, phosphorus, arsenic, germanium or carbon, as required, for the device being fabricated. Etching gases supplied to a process chamber may include halocompounds such as HCl, HBr, BCl₃, Cl₂ and Br₂, and combinations thereof. Hydrogen chloride (HCl) or another halocompound, such as SF₆ or NF₃, may be used to clean the chamber between process runs.

In such processes, only a small proportion of the gas supplied to the process chamber is consumed within the chamber, and so a high proportion of the gas supplied to the chamber is exhausted from the chamber, together with solid and gaseous by-products from the process occurring within the chamber. A process tool typically has a plurality of process chambers, each of which may be at respective different stage in a deposition, etching or cleaning process. Therefore, during processing a waste effluent stream formed from a combination of the gases exhausted from the chambers may have various different compositions.

Before the waste stream is vented into the atmosphere, it is treated to remove selected gases and solid particles therefrom. Acid gases such as HF and HCl are commonly removed from a gas stream using a packed tower scrubber, in which the acid gases are taken into solution by a scrubbing liquid flowing through the scrubber. Silane is pyrophoric, and so before the waste stream is conveyed through the scrubber it is common practice for the waste stream to be conveyed through a thermal incinerator to react silane or other pyrophoric gas present within the waste stream with air. Any perfluoro compounds such as NF₃ may also be converted into HF within the incinerator.

When silane burns, large amounts of silica (SiO₂) particles are generated. Whilst many of these particles may be taken into suspension by the scrubbing liquid within the packed tower scrubber, it has been observed that the capture of relatively smaller particles (for example, having a size less than 1 micron) by the scrubbing liquid is relatively poor. In view of this, it is known to provide an electrostatic precipitator downstream from the scrubber to remove these smaller particles from the waste stream.

Although such apparatus provide for treatment of the effluent gas stream, they have a number of shortcomings. Accordingly, it is desired to provide an improved gas treatment apparatus.

The discussion above is merely provided for general background information and is not intended to be used as an aid in determining the scope of the claimed subject matter. The claimed subject matter is not limited to implementations that solve any or all disadvantages noted in the background.

### SUMMARY

According to a first aspect, there is provided an electrostatic precipitator, comprising: a chamber having an inlet configured to receive an effluent stream for treatment and an outlet configured to convey a treated effluent stream; and an electrode structure housed within the chamber, the electrode structure being operable to generate a corona for treating the effluent stream to produce the treated effluent stream, wherein the electrode structure comprises at least one comb structure having a shaft and a plurality of teeth extending from the shaft, the corona being generated at a free tip of each tooth in response to a voltage when applied across the electrode structure and the chamber.

The first aspect recognizes that a problem with existing electrostatic precipitators is that their efficiency can be poor. In particular, the corona generated by the precipitator can diminish due to accumulation of particulates on the electrodes. Accordingly, an electrostatic precipitator is provided. The precipitator may comprise a housing, enclosure or chamber. The chamber may have an inlet which receives an effluent stream to be treated. The chamber may have an outlet which provides a treated effluent stream. The precipitator may have an electrode structure. The electrode structure may be housed, retained or enclosed within the chamber. The electrode structure may generate a corona to treat the effluent stream and produce the treated effluent stream. The electrode structure may have one or more comb-like structures. The comb structure may have a shaft, support or elongate member with teeth or protrusions extending from the shaft. A corona may be generated at the tip of each tooth when a voltage is applied between the electrode structure and the chamber. In this way, electrode teeth are provided which provide for a reduced area from which the corona is generated, thereby improving the corona, but also the reduced size of the electrode teeth compared to existing electrode structures provides a reduced area for the accumulation of particulates and facilitates the shedding of those particulates from the electrodes, which improves the performance of the electrostatic precipitator.

Each tooth may comprise at least one free end portion which extends from the shaft, the free end portion terminating at the free tip.

The shaft may be elongate and have the plurality of teeth spaced along its axial length. This provides for corona generation along the length of the electrode structure.

A distance between adjacent teeth may be greater than a width of each tooth. This helps to space the teeth apart to provide for efficient corona generation.

A distance between adjacent teeth may be greater than 10 times a width of each tooth.

A height of each tooth may be greater than its width. Accordingly, each tooth may be elongate, upstanding from the shaft or support. This provides a profile which helps to resist the accumulation of particulates.

A height of each tooth may be greater than around 5 times its width. Accordingly, the teeth may have an aspect ratio which is long and narrow.

A thickness of each tooth may match its width. Accordingly, the thickness of each tooth may be less than its length.

At least a portion of each tooth may have parallel sides.

At least the free tip of each tooth may be tapered. This helps to provide for a reduced area used for corona generation as well as reducing the surface on which particulates may accumulate.

The taper may have a taper angle of at least 45°.

The free tip may have a length which is around 1/16th of a total length of the tooth.

The electrode structure may comprise a plurality of comb structures.

The plurality of comb structures may be positioned circumferentially around the chamber.

The free end portions may be orientated to extend radially within the chamber.

The precipitator may comprise a fluid cleaner configured to spray a fluid onto the electrode structure. This helps to remove accumulated particulates from the electrode structure.

The comb structure may comprise a plurality of electrode wires as the teeth extending from at least one electrode support structure as the shaft, the corona being generated at a free tip of each electrode wire in response to a voltage when applied across the electrode structure and the chamber.

The comb structure may have electrode wires or filaments which extend or protrude from the electrode support structure. The corona may be generated at the tip of the electrode wires in response to a voltage applied between the electrode structure and the chamber. In this way, electrode wires or filaments are provided which both provide for a reduced area from which the corona is generated, thereby improving the corona, but also the reduced size of the electrode wires compared to existing electrode structures provides a reduced area for the accumulation of particulates and facilitates the shedding of those particulates from the electrodes, which improves the performance of the electrostatic precipitator.

The electrode wire may comprise at least one free end portion extending from the electrode support structure, the free end portion terminating at the free tip.

The ratio of width to length of the electrode wire may be 1:between 10 and 100. Accordingly, the electrode wire may have a width or cross-sectional dimension which is significantly smaller than its length.

The electrode wire may comprise at least two free end portions, each extending from the electrode support structure, each of which terminate at the free tip. Accordingly, each electrode wire may have a plurality of end portions.

The at least two free end portions may extend from the electrode support structure in diametrically opposing directions. Accordingly, the free end portions may extend in different or opposite directions. Typically, the free end portions may extend away from each other.

The at least two free end portions may extend from the electrode support structure in the same direction.

The free end portion may comprise a mass such as a point mass located towards or proximate the free tip.

The mass structure may comprise a protuberance or body attached to the or received on the free end portion. The mass structure may comprise a bent formation of the free end portion. In other words, the free end portion may be folded or turned in order to form the bent formation.

The electrode wires may comprise legs of a spring.

The electrode wires may comprise legs of a torsion spring.

The electrode wires may comprise legs extending or protruding from a body or the turns of the torsion spring.

The electrode support structure may be elongate on to which the electrode wires may be placed, spaced along the axial length of the electrode support structure. The electrode support structure may be elongate to receive a plurality of the springs along its axial length.

The electrode support may have a cross-section shaped to receive the body of the springs. In other words, the electrode support structure may be shaped to fit the body of the springs.

The electrode structure may have a cross-section which is shaped to receive the body of the springs in a selected or predetermined orientation. This ensures that the free tips face towards the wall of the chamber in order to generate the corona in an appropriate location.

The electrode support may have a cross-section which is shaped to resist, inhibit or prevent rotation of the springs on the electrode support.

The electrostatic precipitator may comprise a plurality of electrode supports.

The plurality of electrode supports may be positioned circumferentially around the chamber.

The free end portions may be orientated to extend or be positioned radially within the chamber.

The electrostatic precipitator may comprise an impulse generator which is configured or operable to impart a mechanical impulse or force to the electrode structure. This force in turn helps to dislodge particulates on the electrode structure and in particular on the electrode wires.

The impulse generator may be a linear actuator and/or an offset motor.

According to a second aspect, there is provided a method of manufacture of an electrostatic precipitator, comprising: providing a chamber having an inlet configured to receive an effluent stream for treatment and an outlet configured to convey a treated effluent stream; forming an electrode structure from at least one comb structure having a shaft and a plurality of teeth extending from the shaft; and housing the electrode structure within the chamber.

Each tooth may comprise at least one free end portion extending from the shaft, the free end portion terminating at the free tip.

The shaft may be is elongate having the plurality of teeth spaced along its axial length.

A distance between adjacent teeth may be greater than a width of each tooth.

A distance between adjacent teeth may be greater than ten times a width of each tooth.

A height of each tooth may be greater than its width.

A height of each tooth may be is greater than five times its width.

A thickness of each tooth may match its width.

At least a portion of each tooth may have parallel sides.

At least the free tip may be tapered.

The taper may have a taper angle of at least 45°.

The free tip may have a length which is around 1/16th of a total length of the tooth.

The electrode structure may comprise a plurality of comb structures.

The forming may comprise positioning the plurality comb structures circumferentially around the chamber.

The forming may comprise orientating the free end portions to extend radially within the chamber.

The method may comprises providing a fluid cleaner configured to spray a fluid onto the electrode structure.

The method may comprise forming the comb structure by placing a plurality of electrode wires as the teeth to extend from at least one electrode support structure as the shaft.

The electrode wire may comprise at least two free end portions, each extending from the electrode support structure, each of which terminate at the free tip.

The at least two free end portions may extend from the electrode support structure in diametrically opposing directions.

The at least two free end portions may extend from the electrode support structure in the same direction.

The free end portion comprise a mass structure located towards the free tip.

The mass structure may comprise a protuberance and the method may comprise receiving the protuberance with the free end portion.

The mass structure may comprise a bent formation of the free end portion.

The electrode wires may comprise legs of a spring.

The electrode wires may comprise legs of a torsion spring.

The electrode wires may comprise legs extending from a body of the torsion spring.

The electrode support structure may be is elongate and the placing may comprise receiving a plurality of electrode wires spaced along its axial length.

The electrode support structure may be elongate and the placing may comprise receiving a plurality of the springs along its axial length.

The electrode support may have a cross-section shaped to receive the body of the springs therearound.

The electrode support may have a cross-section shaped to receive the body of the springs in a selected orientation.

The electrode support may have a cross-section shaped to resist rotation of the body of the springs about the electrode support.

The electrode support may comprise a plurality of electrode supports.

The plurality of electrode may be positioned circumferentially around the chamber.

The placing may comprise orientating the free end portions to extend radially within the chamber.

The method may comprise fitting an impulse generator configured to impart a mechanical impulse to the electrode structure.

The impulse generator may be at least one of a linear actuator and an offset motor.

According to a third aspect, there is provided an electrostatic precipitator, comprising: a chamber having an inlet configured to receive an effluent stream for treatment and an outlet configured to convey a treated effluent stream; and

an electrode structure housed within the chamber, the electrode structure being operable to generate a corona for treating the effluent stream to produce the treated effluent stream, wherein the electrode structure comprises a plurality of electrode wires extending from at least one electrode support structure, the corona being generated at a free tip of each electrode wire in response to a voltage when applied across the electrode structure and the chamber.

The third aspect recognizes that a problem with existing electrostatic precipitators is that their efficiency can be poor. In particular, the corona generated by the precipitator can diminish due to accumulation of particulates on the electrodes.

Accordingly, an electrostatic precipitator is provided. The electrostatic precipitator may comprise a chamber or housing which has an inlet which receives an effluent stream to be treated. The chamber may have an outlet which provides a treated effluent stream. The chamber may house or contain an electrode structure or assembly. The electrode structure may generate a corona to treat the effluent stream. The electrode structure may have electrode wires or filaments which extend or protrude from the electrode support structure. The corona may be generated at the tip of the electrode wires in response to a voltage applied between the electrode structure and the chamber. In this way, electrode wires or filaments are provided which both provide for a reduced area from which the corona is generated, thereby improving the corona, but also the reduced size of the electrode wires compared to existing electrode structures provides a reduced area for the accumulation of particulates and facilitates the shedding of those particulates from the electrodes, which improves the performance of the electrostatic precipitator.

The electrode wire may comprise at least one free end portion extending from the electrode support structure, the free end portion terminating at the free tip.

The ratio of width to length of the electrode wire may be 1:between 10 and 100. Accordingly, the electrode wire may have a width or cross-sectional dimension which is significantly smaller than its length.

The electrode wire may comprise at least two free end portions, each extending from the electrode support structure, each of which terminate at the free tip. Accordingly, each electrode wire may have a plurality of end portions.

The at least two free end portions may extend from the electrode support structure in diametrically opposing directions. Accordingly, the free end portions may extend in different or opposite directions. Typically, the free end portions may extend away from each other.

The at least two free end portions may extend from the electrode support structure in the same direction.

The free end portion may comprise a mass such as a point mass located towards or proximate the free tip.

The mass structure may comprise a protuberance or body attached to the or received on the free end portion. The mass structure may comprise a bent formation of the free end portion. In other words, the free end portion may be folded or turned in order to form the bent formation.

The electrode wires may comprise legs of a spring.

The electrode wires may comprise legs of a torsion spring.

The electrode wires may comprise legs extending or protruding from a body or the turns of the torsion spring.

The electrode support structure may be elongate on to which the electrode wires may be placed, spaced along the axial length of the electrode support structure. The electrode support structure may be elongate to receive a plurality of the springs along its axial length.

The electrode support may have a cross-section shaped to receive the body of the springs. In other words, the electrode support structure may be shaped to fit the body of the springs.

The electrode structure may have a cross-section which is shaped to receive the body of the springs in a selected or predetermined orientation. This ensures that the free tips face towards the wall of the chamber in order to generate the corona in an appropriate location.

The electrode support may have a cross-section which is shaped to resist, inhibit or prevent rotation of the springs on the electrode support.

The electrostatic precipitator may comprise a plurality of electrode supports.

The plurality of electrode supports may be positioned circumferentially around the chamber.

The free end portions may be orientated to extend or be positioned radially within the chamber.

The electrostatic precipitator may comprise an impulse generator which is configured or operable to impart a mechanical impulse or force to the electrode structure. This force in turn helps to dislodge particulates on the electrode structure and in particular on the electrode wires.

The impulse generator may be a linear actuator and/or an offset motor.

According to a fourth aspect, there is provided a method of manufacture of an electrostatic precipitator, comprising: providing a chamber having an inlet configured to receive an effluent stream for treatment and an outlet configured to convey a treated effluent stream; forming an electrode structure by placing a plurality of electrode wires to extend from at least one electrode support structure; and housing the electrode structure within the chamber.

The electrode wire may comprise at least two free end portions, each extending from the electrode support structure, each of which terminate at the free tip.

The at least two free end portions may extend from the electrode support structure in diametrically opposing directions.

The at least two free end portions may extend from the electrode support structure in the same direction.

The free end portion comprise a mass structure located towards the free tip.

The mass structure may comprise a protuberance and the method may comprise receiving the protuberance with the free end portion.

The mass structure may comprise a bent formation of the free end portion.

The electrode wires may comprise legs of a spring.

The electrode wires may comprise legs of a torsion spring.

The electrode wires may comprise legs extending from a body of the torsion spring.

The electrode support structure may be is elongate and the placing may comprise receiving a plurality of electrode wires spaced along its axial length.

The electrode support structure may be elongate and the placing may comprise receiving a plurality of the springs along its axial length.

The electrode support may have a cross-section shaped to receive the body of the springs therearound.

The electrode support may have a cross-section shaped to receive the body of the springs in a selected orientation.

The electrode support may have a cross-section shaped to resist rotation of the body of the springs about the electrode support.

The electrode support may comprise a plurality of electrode supports.

The plurality of electrode may be positioned circumferentially around the chamber.

The placing may comprise orientating the free end portions to extend radially within the chamber.

The method may comprise fitting an impulse generator configured to impart a mechanical impulse to the electrode structure.

The impulse generator may be at least one of a linear actuator and an offset motor.

Further particular and preferred aspects are set out in the accompanying independent and dependent claims. Features of the dependent claims may be combined with features of the independent claims as appropriate, and in combinations other than those explicitly set out in the claims.

Where an apparatus feature is described as being operable to provide a function, it will be appreciated that this includes an apparatus feature which provides that function or which is adapted or configured to provide that function.

The Summary is provided to introduce a selection of concepts in a simplified form that are further described in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

Embodiments of the present invention will now be described further, with reference to the accompanying drawings, in which:

FIG. 1 illustrates an electrostatic precipitator 1 according to one embodiment;

FIG. 2 is a magnified view of a portion of an electrode support structure according to one embodiment;

FIG. 3 illustrates schematically a partial cross-section through the electrostatic precipitator;

FIG. 4 illustrates an electrostatic precipitator according to one embodiment;

FIG. 5 illustrates an electrode support structure according to one embodiment;

FIG. 6 illustrates a torsion spring;

FIG. 7 illustrates torsion springs fitted to the electrode support structure; and

FIG. 8 illustrates schematically a partial cross-section through the electrostatic precipitator.

### DETAILED DESCRIPTION

Before discussing the embodiments in any more detail, first an overview will be provided. Some embodiments provide an arrangement which provides for an efficient technique for generating a corona within an electrostatic precipitator with a reduced build-up of particulates. In some embodiments, an electrode is provided which is formed from an elongate structure resembling a short, flat comb where teeth or protrusions which are narrower than they are long extend from a shaft or support. The end of the tooth generates an increased corona current due to its sharper electrode tip which can be pointed or tapered if required. Also, the shape and size of the electrode, which is long and thin, is effective at preventing build-up of particulates on that electrode tip. Conveniently, the teeth can be provided by stamping or cutting the comb structure from a plate which can be readily placed onto a support structure. In some embodiments, a fluid cleaner is provided within the precipitator chamber in order to help dislodge accumulated particulates on the electrode structure. In some embodiments, an electrode is provided which is formed from an elongate protrusion such as a wire or filament. The end of the wire generates an increased corona current due to its sharper electrode tip which can be pointed or tapered if required. Also, the shape and size of the electrode is effective at preventing build-up of particulates on that electrode tip. Conveniently, the wire may be provided by one or more legs of a spring, such as a torsion spring, which simplifies the manufacture of the electrode structure since the springs can be readily placed and orientated onto an electrode support structure. In some embodiments, an additional mass is placed towards the free end of the electrode in order to facilitate its displacement under mechanical movement in order to help dislodge accumulated particulates.

### Electrostatic Precipitator—1^{st} Arrangement

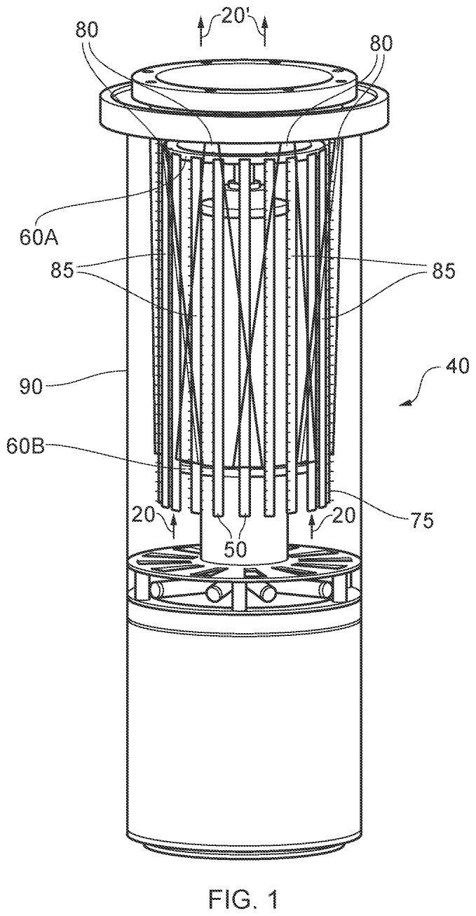

FIG. 1 illustrates an electrostatic precipitator 10 according to one embodiment. The electrostatic precipitator 10 has a housing 90 having inlets (not shown) which receive an effluent stream 20 and outlets (not shown) which provide a treated effluent stream 20′. In this embodiment, the housing 90 is generally cylindrical in shape. However, it will be appreciated that the housing 90 may be of any suitable shape and that the inlets and the outlets may be located at any suitable position.

### Electrode Support Structure

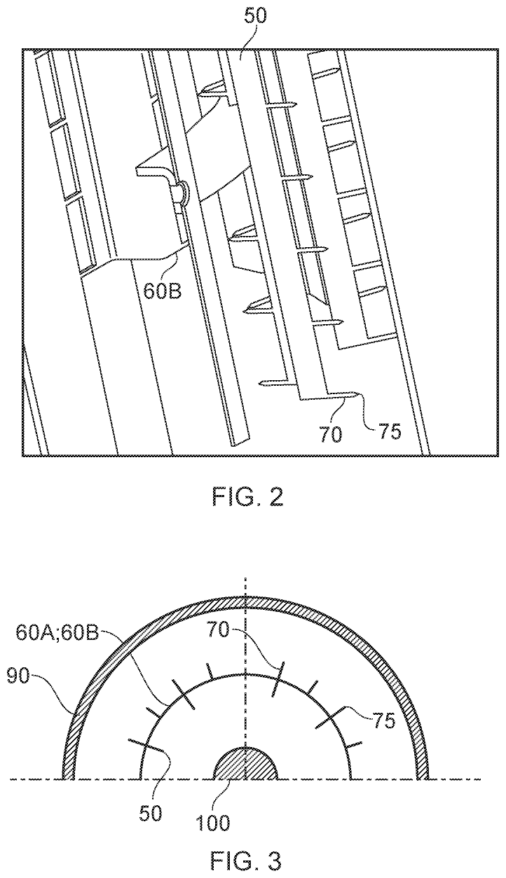

FIG. 2 is a magnified view of a portion of an electrode support structure 40 according to one embodiment. The electrode support structure 40 is received within the housing 90. In this embodiment, the electrode support structure 40 is coaxially located within the housing 90. The electrode support structure 40 is dimensioned to be spaced away from the housing 90 and extends along an elongate axis of the housing 90. An electrical coupling (not shown) couples to the electrode support structure 40. The electrode support structure 40 is electrically isolated from the housing 90. The electrode support structure 40 comprises a number of shafts 50. In this example, the shafts 50 are planar or elongate plates and extend along the elongate axis of the housing 90 between annular supports 60A, 60B. The shafts 50 are positioned circumferentially around the annular supports 60A, 60B. A number of axially spaced teeth 70 extend radially from the shafts 50. In this embodiment, the teeth 70 are formed integrally with the shafts 50. In particular, the shaft 50 and the teeth 70 are formed from a metal plate which is stamped or cut to form the comb structure. Conveniently, the shafts 50 may be bent or folded to provide a surface for fixing to the annular supports 60A, 60B. The free tip 75 of each tooth 70 is typically tapered with a taper angle of around 45°. However, it will be appreciated that this need not be the case and that no taper or a greater taper angle may be provided. Typically, the thickness of the shaft 50 and the teeth 70 is between around 0.1 mm to 1 mm, the width of the teeth is also between 0.1 mm to 1 mm and the length of the teeth 70 is typically between around 10 mm and 100 mm, depending on design requirements.

FIG. 3 illustrates schematically a partial cross-section through the electrostatic precipitator 10. As can be seen, the electrode support structure 40 is located coaxially within the housing 90. Also within the housing 90 is a coaxially located inner wall 100. The annular supports 60A, 60B are positioned between the housing 90 and the inner wall 100. The comb structures comprising the shafts 50 and the teeth 70 are located on the annular supports 60A, 60B. The teeth 70 are orientated radially within the housing 90.

To assemble the precipitator, the comb structures comprising the shaft 50 and the teeth 70 are formed by stamping or cutting sheet metal and the shaft 50 is typically folded to facilitate coupling with the annular supports 60A, 60B and orientate the teeth 70 in the radial direction. The electrode support structure 40 is then placed within the housing 90.

In operation, a voltage is applied across the electrode support structure 40 and the housing 90 and the inner wall 100. This generates a corona at the tips 75 of each tooth 70. The tips 75 may be formed into a tapering point if required. The generated corona treats the incoming effluent stream 20 and provides a treated effluent stream 20′ which exits through the outlets.

The shape and dimensions of the teeth 70 help to resist the build-up of particulate matter on the electrode support structure 40. To further assist in removal of build-up particulate matter, a number of fluid jets 80 are located circumferentially around the housing 90 and provide a fluid spray 85 onto the electrode support structure in order to help dislodge any accumulated particulates.

Some embodiments provide a simple design for electrostatic precipitator to create cost effective miniature electrode spikes. The electrodes are prepared from thin protrusions or elongate members to prevent particulate build-up on the electrodes which otherwise results in a reduction of performance and subsequent longevity of operation due to particulate build-up.

It has been found that the performance of an electrostatic precipitator rapidly declines in operation due to the build-up of particulates on the electrode tips. In tests it has been found that the concentration of silica which results in the exhaust of the precipitator, can be an order of magnitude lower with a freshly cleaned system than for a system which has been running a number of hours and debris have been allowed to adhere to the electrode tips thus reducing their performance. The sharpness of an electrode tip can effect the corona current generated for a given voltage, where a sharper electrode tip provides for increased corona current. The build-up of material on the electrode has been shown to reduce the coronal current of the precipitator. ‘Rapping’ is a technique whereby a mechanical striking of the electrode can cause debris to be dislodged, however this is not sufficient to dislodge all debris in all systems. Depending on the nature of the material/dust which forms debris on the electrode, or if the debris have been formed in moist layers this can result in a particularly strong mechanical adhesion of particulates to the electrode. Air purging of the electrodes can require significant and very directional volumes of air to allow debris to be dislodged. Washing with a spray however proved to be very effective in restoring corona current and hence particulate removal performance.

In some embodiments there are around 800 electrode tips in the design. These are constructed with a sharp tip of 45 degree angle and prepared preferably from 1 mm thick 316 or 304 stainless steel and 1 mm wide in dimension. The electrodes may be laser cut or water jet cut from sheet steel. The manufacturing method allows for ease of construction of many tips in one part and ease of assembly via an integrated support.

In operation, the electrode tips were found to be maintained free of debris, such that a corona glow remains visible, the corona current is maintained at higher value and particulate capture is enhanced. Tests were performed at slightly increased voltage with the spike electrodes since less particulates were found to build up and therefore less arcing occurred, meaning the voltage could be increased. The corona current was found to be maintained at a much higher value and depreciates to a lesser extent also.

It is unexpected that marginally changing the shape of electrodes would achieve such an appreciable improvement in performance. This is due to preventing the mass of particulate to increase beyond a point when the coronal current generation is effected upon.

### Electrostatic Precipitator—2^{nd} Arrangement

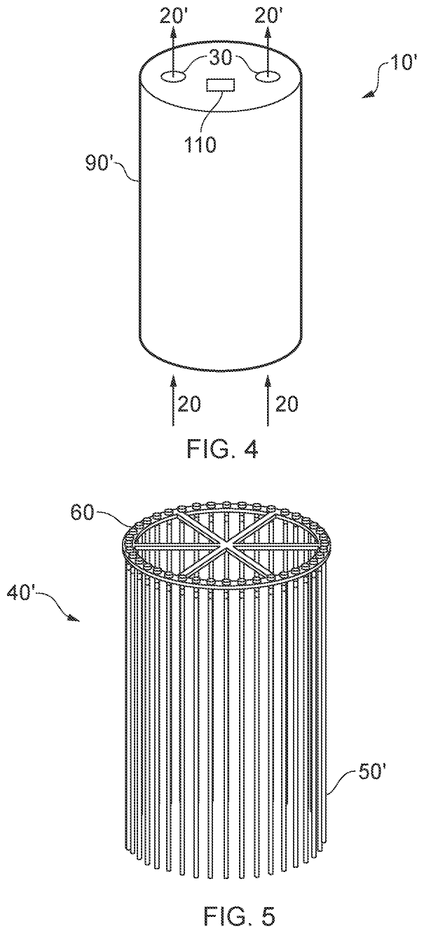

FIG. 4 illustrates an electrostatic precipitator 10′ according to one embodiment. The electrode static precipitator 10′ has a housing 90′ having inlets (not shown) which receive an effluent stream 20 and outlets 30 which provide a treated effluent stream 20′. In this embodiment, the housing 90′ is generally cylindrical in shape. However, it will be appreciated that the housing may be of any suitable shape and that the inlets and the outlets 30 may be located at any suitable position.

### Electrode Support Structure

FIG. 5 illustrates an electrode support structure 40′ according to one embodiment. The electrode support structure 40′ is received within the housing 90′. In this embodiment, the electrode support structure 40′ is coaxially located within the housing 90′. The electrode support structure 40′ is dimensioned to be spaced away from the housing 90′ and extends along an elongate axis of the housing 90′. An electrical coupling (not shown) couples to the electrode support structure 40′. The electrode support structure 40′ is electrically isolated from the housing 90′.

The electrode support structure 40′ comprises a number of rods 50′. In this example, the rods 50′ are cylindrical and extend along the elongate axis of the housing 90′ from an annular support 60. The rods 50′ are positioned circumferentially around the annular support 60. Although in this embodiment the rods 50′ are cylindrical, having a generally circular cross-section but, as will be explained below, this need not be the case.

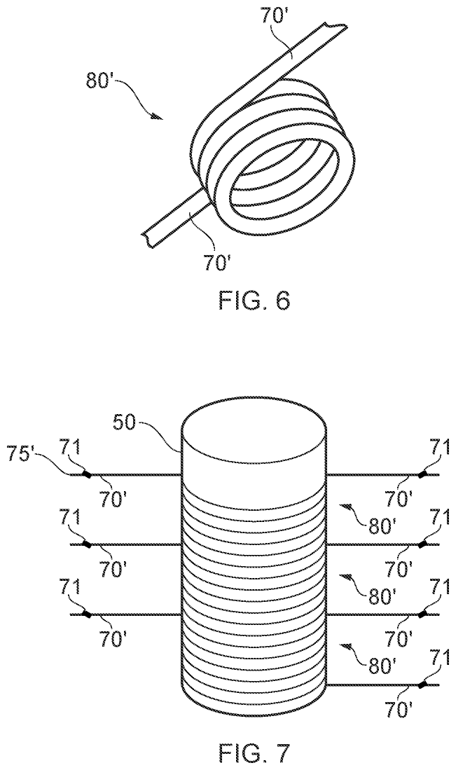

A number of axially spaced wires are arranged to extend radially from the rods 50′. In some embodiments, the wires pass through holes in the rods 50′. However, in other embodiments the wires are provided by free ends 70′ of a torsion spring 80′, as illustrated in FIG. 6. The inner diameter of the turns of the torsion spring 80′ is dimensioned to provide a close fit on the outer diameter of the rods 50′. The torsion springs 80′ are placed over the rods 50′, as illustrated in FIG. 7. In this embodiment, the torsion springs 80′ have two free ends 70′ which extend in opposite directions. However, it will be appreciated that this need not be the case and that only one free end 70′ need be provided. Furthermore, the free ends 70′ illustrated in FIG. 6 extend tangentially from the torsion spring 80′. However, it will be appreciated that this need not be the case and that the free ends 70′ may instead extend radially. Furthermore, in this embodiment the turns of the torsion springs 80′ and the cross-section of the rods 50′ are circular. However, it will be appreciated that noncircular cross-sections and turns may be provided (for example triangular, square, hexagonal and the like), as this will facilitate aligning the orientation of the free ends 70′ to a desired orientation. Typically, the thickness of the wire is between around 0.1 mm to 1 mm and the length of the free ends are between around 10 mm to 100 mm depending on design requirements.

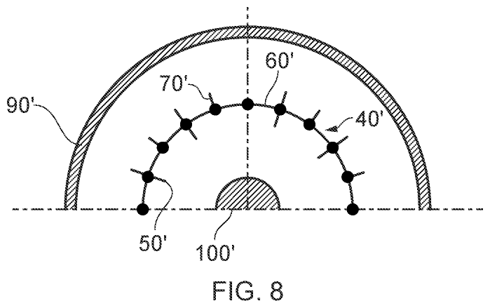

FIG. 8 illustrates schematically a partial cross-section through the electrostatic precipitator 10′. As can be seen, the electrode support structure 40′ is located coaxially within the housing 90′. Also within the housing 90′ is a coaxially located inner wall 100′. The annular support 60 is positioned between the housing 90′ and the inner wall 100′. The torsion springs 80′ located on the rods 50′ are orientated radially within the housing 90′. In some embodiments, a mass 71 is located on the free ends 70′ towards their tips 75′. The mass 71 may slide over or attach to the wire of the torsion springs 80′ or may be formed by folding or turning the wire of the torsion springs 80′.

To assemble the precipitator, the electrode support structure 40′ is formed, with the rods 50′ extending in the axial direction. In some embodiments, torsion springs 80′ are placed over the rods 50′. Typically, the springs abut each other on the rods 50′. However, spacer may be provided between the torsion springs 80′ if required. Where the rods 50′ are noncircular and shaped to engage with the torsion springs 80′ in a predetermined orientation, the rods 50′ are orientated on the annular support 60′ so that once the torsion springs 80′ are placed on the rods 50′, the torsion springs 80′ are already orientated radially. Where the rods 50′ and the torsion springs 80′ are circular in cross-section, the torsion springs 80′ are then orientated radially, as shown in FIG. 8.

In operation, a voltage is applied across the electrode support structure 40′ and the housing 90′ and the inner wall 100′. This generates a corona at the tips 75′ of each free end 70′. The tips 75′ may be formed into a tapering point if required. The generated corona treats the incoming effluent stream 20 and provides a treated effluent stream 20′ which exits through the outlets 30. The shape and dimensions of the free ends 70′ help to resist the build-up of particulate matter on the torsion springs 80′. To further assist in removal of built-up particulate matter, a vibration device 110, which can consist of, for example, a solenoid or offset motor, can be actuated to impart a force onto the housing 90′ and/or directly onto the electrode support structure 40′, in order to induce vibration or movement in the free ends 70′. Such movements of the free ends 70′ may be enhanced by the presence of the masses 71.

Hence, it can be seen that some embodiments provide a simple design for an electrostatic precipitator which has miniature electrode spikes. The electrodes are prepared from thin wire to prevent particulate build-up on the electrodes which otherwise results in a reduction of performance and subsequent longevity of operation due to particulate build-up.

The preparation of the electrodes from torsion springs on supporting rods means that the electrode tips can be made to smaller dimensions than would otherwise be achieved with laser cutting of sheet metal, due to the width of the laser beam and heat dissipation limiting the size that electrode spikes can be manufactured to. The electrostatic precipitator or wet-electrostatic precipitator consists of many electrodes (typically 500-1500) in abatement systems, which can make their manufacture challenging while maintaining a reliable plate-electrode separation distance.

The build up of particulates which occurs as result of using the precipitator to remove particulates is minimised by having electrodes made of thin wires. Compared with pre-existing designs this is shown to reduce the mass of particulate adhering to the electrodes and thus maintains the corona current.

By reducing the build up of particulates on the electrode, the reduction in electrode to plate spacing which would normally occur as a result of excessive particulate build-up is less significant, reducing the possibility of arcing or permanent shorts. This causes the mean time between services to be increased.

By using spring steel, there is a natural vibration to the wire which makes cleaning of the electrodes by ‘rapping’ (mechanically striking the electrodes to remove debris) or acoustic methods more effective and feasible.

By using individual torsion springs, two electrodes can be replaced at a time if required, instead of having to replace an entire suite of electrodes.

As mentioned above, it has been found that the performance of a wet electrostatic precipitator rapidly declines in operation due to the build-up of particulates on the electrode tips. In tests it has been found that the concentration of silica which results in the exhaust of the electrostatic precipitator or wet-electrostatic precipitator, can be an order of magnitude lower with a freshly cleaned system than for a system which has been running a number of hours and debris have been allowed to adhere to the electrode tips thus reducing their performance.

The sharpness of an electrode tip is known to effect upon the corona current generated for a given voltage, where a sharper electrode tip provides for increased corona current. The build-up of material on the electrode has been shown to reduce the coronal current of the electrostatic precipitator or wet-electrostatic precipitator.

‘Rapping’ is a known technique whereby a mechanical striking of the electrode can cause debris to be dislodged, however this is not sufficient to dislodge all debris in all systems. Depending on the nature of the material/dust which forms debris on the electrode, or if the debris have been formed in moist layers this can result in a particularly strong mechanical adhesion of particulates to the electrode. Air purging of the electrodes was shown to require significant and very directional volumes of air to allow debris to be dislodged.

By reducing the diameter of the electrode tip however, the surface can only sustain a certain mass of particulate and therefore deposited particulate are observed to break off and the coronal current is better maintained.

In some embodiments, there are around 800 electrode tips. These are constructed from torsion springs made from spring steel, 304 or 316 hardened steel. The wires may be prepared as thin as 0.1 mm-1 mm whilst still being mechanically robust due to the nature of the spring steel. Preferably the wires are made from 0.3 mm 316 spring steel.

The torsions springs/wires can be slid onto metal rods, providing a simple method of manufacture and retaining the directionality of electrode tips towards the earth plate.

It is counter intuitive to marginally change the shape of electrodes and achieve such an appreciable improvement in performance. This is due to preventing the mass of particulate to increase beyond a point when the coronal current generation is affected upon.

Although illustrative embodiments of the invention have been disclosed in detail herein, with reference to the accompanying drawings, it is understood that the invention is not limited to the precise embodiment and that various changes and modifications can be effected therein by one skilled in the art without departing from the scope of the invention as defined by the appended claims and their equivalents.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are described as example forms of implementing the claims.

1. An electrostatic precipitator, comprising:
a chamber having an inlet configured to receive an effluent stream for treatment and an outlet configured to convey a treated effluent stream; and
an electrode structure housed within said chamber, said electrode structure being operable to generate a corona for treating said effluent stream to produce said treated effluent stream, wherein said electrode structure comprises at least one comb structure having a shaft and a plurality of teeth extending from said shaft, said corona being generated at a free tip of each tooth in response to a voltage when applied across said electrode structure and said chamber.

2. The electrostatic precipitator of claim 1, wherein each tooth comprises at least one free end portion extending from said shaft, said free end portion terminating at said free tip.

3. The electrostatic precipitator of claim 1, wherein said shaft is elongate having said plurality of teeth spaced along its axial length.

4. The electrostatic precipitator of claim 1, wherein a distance between adjacent teeth is greater than a width of each tooth and preferably greater than ten times a width of each tooth.

5. The electrostatic precipitator of claim 1, wherein a height of each tooth is greater than its width and preferably greater than five times its width.

6. The electrostatic precipitator of claim 1, wherein at least said free tip is tapered and preferably wherein said taper has a taper angle of at least 45°.

7. The electrostatic precipitator of claim 1, wherein said free tip has a length which is around 1/16th of a total length of said tooth.

8. The electrostatic precipitator of claim 1, comprising a plurality of comb structures and preferably wherein said plurality comb structures are positioned circumferentially around said chamber.

9. The electrostatic precipitator of claim 1, wherein said free end portions are orientated to extend radially within said chamber.

10. The electrostatic precipitator of claim 1, comprising a fluid cleaner configured to spray a fluid onto said electrode structure.

11. The electrostatic precipitator of claim 1, wherein said comb structure comprises a plurality of electrode wires as said teeth extending from at least one electrode support structure as said shaft,

12. The electrostatic precipitator of claim 11, wherein said electrode wire comprises at least one free end portion extending from said electrode support structure, said free end portion terminating at said free tip.

13. The electrostatic precipitator of claim 12, wherein said free end portion comprise a mass structure located towards said free tip.

14. The electrostatic precipitator of claim 11, wherein said electrode wires comprise legs of a spring.

15. A method of manufacture of an electrostatic precipitator, comprising:
providing a chamber having an inlet configured to receive an effluent stream for treatment and an outlet configured to convey a treated effluent stream;
forming an electrode structure from at least one comb structure having a shaft and a plurality of teeth extending from said shaft; and
housing said electrode structure within said chamber.
